(19) United States
(12) Patent Application Publication
(10) Pub. No.: US 2007/0034424 A1
(43) Pub. Date: Feb. 15, 2007

(54) Power-assisted transport device

(76) Inventors: Nancy C.G. Snowden, Mt. Pleasant, SC (US); Janice E. Durden, Charleston, SC (US)

Correspondence Address: BANNER & WITCOFF, 1001 G STREET N W, SUITE 1100, WASHINGTON, DC, 20001, US

(21) Appl. No.: 11/202,202

(22) Filed: Aug. 12, 2005

(51) Int. Cl. B60K 1/00

(52) U.S. Cl. 180/65.1

(57) ABSTRACT

An apparatus for assisting a user in transporting a load bearing device is described. The apparatus including an external housing with an opening, an interior storage compartment, a drive wheel operatively connected to a drive belt, configured to propel the device across a surface, and at least one input switch, operatively connected to the power controller, configured to engage movement of the device upon activation of the at least one switch. The interior storage compartment may include a battery, a power controller operatively connected to the battery, circuitry, operatively connected to the power controller, configured to control input of power to a motor, and the motor, operatively connected to the circuitry, configured to turn the drive belt operatively connected to the motor and the drive wheel. The battery may be connected to an outlet, in the external housing, configured to permit insertion of a device to use the battery.

### FIELD OF THE INVENTION

Aspects of the present invention are directed generally to a load bearing transport device. More particularly, aspects of the present invention are directed to a self-contained power-assisted transport device that may be integrated into an existing luggage or cart device for assisting a user in moving the luggage or cart device.

### BACKGROUND OF THE INVENTION

Air travel, whether for business or personal reasons, is one of the most common types of travel. For 2004, the U.S. Department of Transportation's Bureau of Transportation Statistics reported that U.S. airlines carried 629.7 million domestic passengers. This statistic does not even take into account non-U.S. airlines carrying domestic passengers, international flights by any airline, or foreign domestic flights. Well over 1 billion passengers were transported through the air for business and personal reasons in 2004. Historically, these numbers of passengers have steadily increased over the years.

As more and more people use airlines to accommodate their need to reach a destination, ways and manners for handling and transporting baggage of the people have increased. Today, travel equipment comes in a variety of shapes, sizes, and uses. FIGS. 1A-1B show conventional types of luggage. Some luggage include wheels to allow a user to roll the luggage from one place to another by pulling on a strap attached to the luggage, such as shown in FIG. 1A, or by using a retractable handle on the luggage, such as shown in FIG. 1B. Such conventional systems allow a user to place the majority of the load being transported onto the luggage while the user pulls the load along. However, use of such systems becomes limited when a user needs additional assistance. For example, the amount of force increases for a user when climbing a hill or incline. In addition, if the user has some type of disability, the amount of force just to move such a conventional device may be too much for many to handle.

Some conventional luggage systems have been developed for self-propulsion. FIG. 1C shows one such conventional device. By use of a separate signal transmitter, the luggage follows a person holding/carrying the transmitter. Such a device helps to place the load in the luggage completely away from the user; however, such a conventional system requires a high degree of precision to ensure safety for others around the luggage, requires a continuous wireless transmission to a receiver in the luggage, does not address rapid changes in direction or movement of a user, such as when the user is in an airport, requires a great deal of internal circuitry and hardware to integrate into an existing piece of luggage, and is much more costly to integrate into a piece of luggage.

### SUMMARY OF THE INVENTION

There exists a need for a self-contained power-assisted transport device that may be integrated into an existing luggage or cart device for assisting a user in moving the luggage or cart device. Aspects of the present invention are directed to a power-assisted transport device including an external housing with an opening, an interior storage compartment, a drive wheel, and an input switch. The interior compartment may include a power supply, a power controller, circuitry for controlling the input of power to a motor, and the motor itself. The drive wheel may be operatively connected to a drive belt and the motor to propel the device across a surface. The input switch may be configured to engage movement of the device upon activation.

Aspects of this invention provide a battery configured to conform to FAA regulations for transporting electric-powered devices. Other aspects provide for a control input configured to control a direction and/or speed of rotation of the motor and a power converter configured to convert power from the power supply to an electrical outlet connected to the external housing.

Another aspect of the invention provides a piece of luggage configured to recharge an external power supply and/or to allow an external device to connect to an internal power supply of the luggage. The piece of luggage may include an exterior housing, an interior storage compartment, a power supply, a connection on the exterior housing, and power lines connecting the connection to the power supply. The connection may permit the insertion of a male electrical connector of an external device to use power from the power supply of the piece of luggage.

### BRIEF DESCRIPTION OF THE DRAWINGS

The foregoing summary of the invention, as well as the following detailed description of illustrative embodiments, is better understood when read in conjunction with the accompanying drawings, which are included by way of example, and not by way of limitation with regard to the claimed invention.

FIGS. 1A-1C illustrate conventional pieces of luggage and manners for moving the luggage;

FIG. 2 shows an illustrative block diagram of a power-assisted transport device in accordance with at least one aspect of the present invention;

FIGS. 3A-3B show illustrative diagrams of a power-assisted transport device in accordance with at least one aspect of the present invention;

FIG. 3C shows an illustrative schematic diagram of a power-assisted transport device in accordance with at least one aspect of the present invention;

FIG. 4A shows an illustrative cross section diagram of a power-assisted transport device in accordance with at least one aspect of the present invention;

FIGS. 4B-4E show illustrative diagrams of a power-assisted transport devices in accordance with at least one aspect of the present invention;

FIG. 4F shows an illustrative schematic diagram of another power-assisted transport device in accordance with at least one aspect of the present invention; and

FIG. 5 is an illustrative diagram of a transport device in accordance with at least one aspect of the present invention.

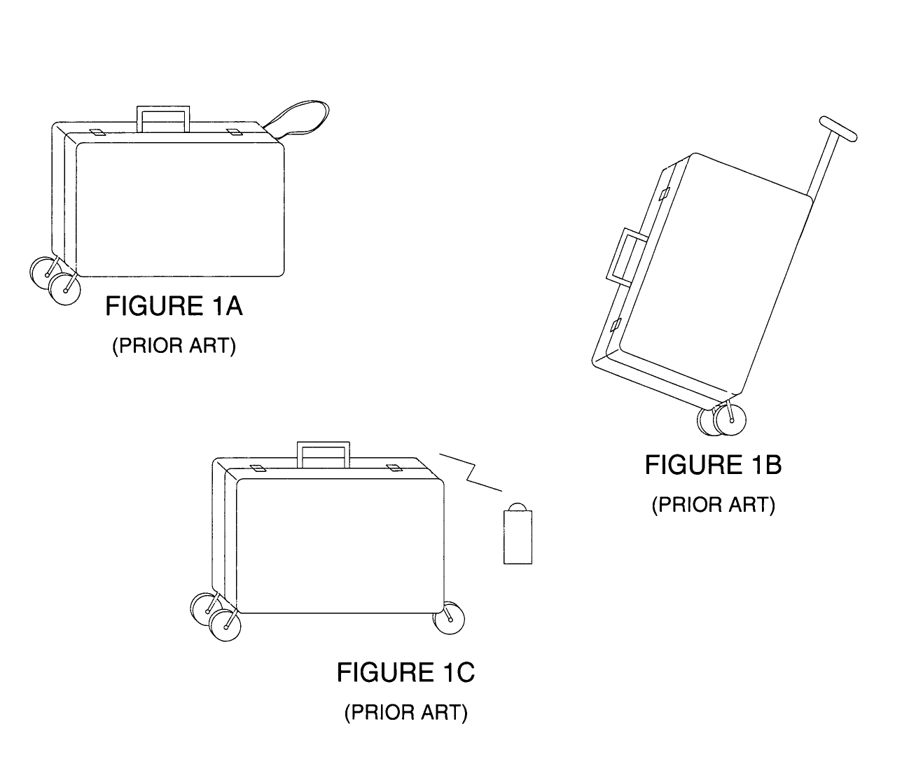

### DETAILED DESCRIPTION OF ILLUSTRATIVE EMBODIMENTS

In the following description of various illustrative embodiments, reference is made to the accompanying drawings, which form a part hereof, and in which is shown, by way of illustration, various embodiments in which the invention may be practiced. It is to be understood that other embodiments may be utilized and structural and functional modifications may be made without departing from the scope of the present invention.

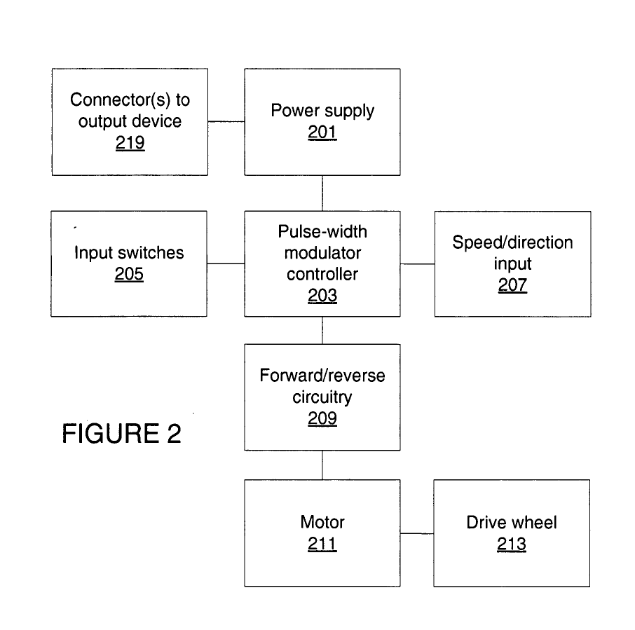

FIG. 2 illustrates an example of a block diagram of components of a power-assisted transport device in accordance with at least one aspect of the present invention. A power supply 201 is operatively connected, directly and/or indirectly, to a pulse-width modulator controller 203. A pulse-width modulator controller 203 is one type of power controller. As known by those skilled in the art, a pulse-width modulator, also known as a variable duty-cycle controller, is highly efficient. In effect, a pulse-width modulator controls the amount of power sent to a load. A pulse-width modulator increases battery performance by greatly reducing power consumption within the controller and avoiding excessive heat build-up within the transport device over the range of motor loads and speeds. Power supply 201 may include sealed rechargeable lead-acid type batteries. Those skilled in the art would appreciate that these types of batteries are commonly referred to as GEL cells. Sealed rechargeable lead-acid type batteries are featured to be compatible with FAA and airline regulations for transporting electric-powered type devices. Other types of batteries that may be used for power supply 201 include a lithium-type battery. Such a type of battery may reduce the weight of the power supply by ⅔ compared to a GEL cell type battery allowing a passenger to load more items while still conforming to airline weight restrictions. Alternative types of power supplies may be included and the present invention is not so limited to the types of batteries described herein. Power supply 201 may be configured to ensure operation of the transport device over various inclined surfaces for a distance of at least two miles. In accordance with at least one aspect of the present invention, power supply 201 may be configured to recharge when a drive wheel 213 rotates in response to a force applied from a source other than a motor 211. For example, power supply 201 may be configured to recharge when a user is moving the device in a manner without power supplied to the power-assist aspects, such as when the user is merely pulling the device. Rotation of one or more wheels of the device may act to recharge the power supply 201.

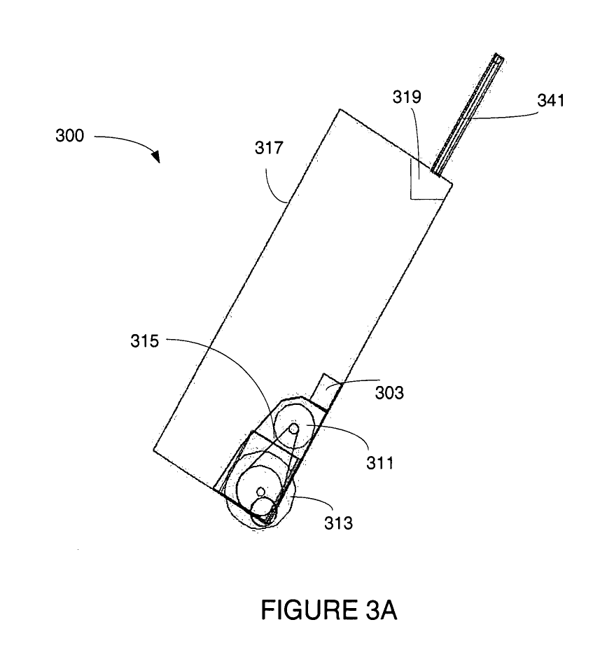

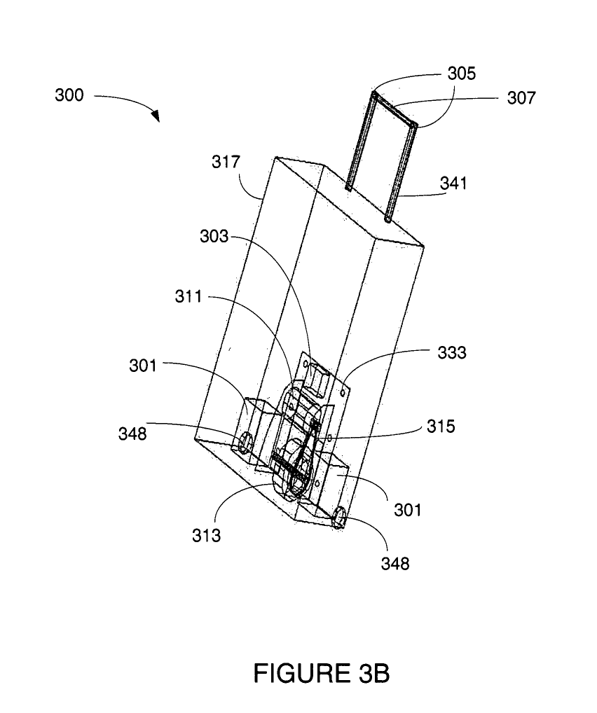

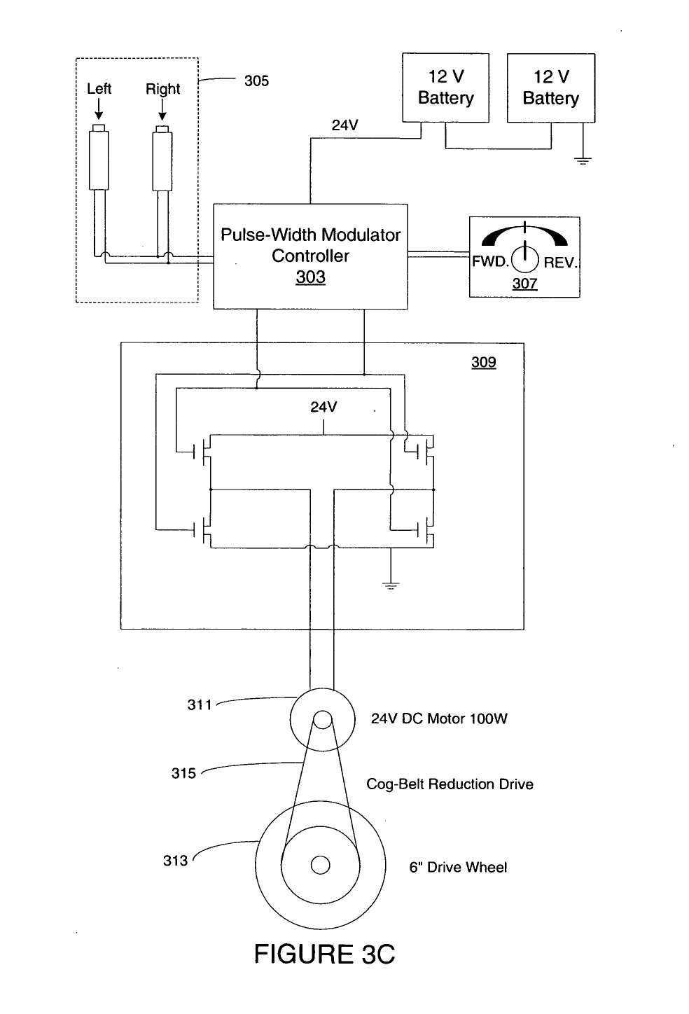

The pulse-width modulator controller 203 is shown operatively connected, directly and/or indirectly, to forward/reverse circuitry 209. Forward/reverse circuitry 209 is controlled by the pulse-width modulator controller 203. Circuitry 209 controls the power output to a motor 211. Circuitry 209 may consist of four power field-effect transistors arranged in an H-bridge configuration that allows remote control of the direction of rotation of the motor 211. One configuration of an H-bridge is shown in circuitry 309 in FIG. 3C. Operation and configuration of an H-bridge is known by those skilled in the art. The following is one example of such an operation and configuration.

In an H-bridge configuration, there are two inputs, A and B, and two outputs, 1 and 2. If input A is brought high, output 1 goes high and output 2 goes low. In response motor 211 rotates in one direction, such as a forward direction. If input B is brought high, output 2 goes high and output 1 goes low. In response, motor 211 rotates in a second, opposite direction, such as a reverse direction. If both inputs A and B are low, motor 211 is not driven, e.g., floats, and may freely coast without consuming any power. In such a case, the transport device can be freely pulled or pushed with a rolling resistance only slightly higher than standard transport devices of the same weight. In the case that both inputs A and B are brought high, motor 211 may be shorted to allow for braking of the transport device. Table 1 is a truth table showing the operation of inputs to outputs.

TABLE 1
Truth Table for H-bridge Configuration

| | |
|---|---|
| Input | Output |

| | | | |
|---|---|---|---|
| A | B | 1 | 2 |

| | | |
|---|---|---|
| 0 | 0 | float |

| | | | |
|---|---|---|---|
| A | 0 | A | 0 |
| 0 | B | 0 | B |
| A | B | A | B |

Reverse-current protection of the power field effect transistors in the H-bridge may include the use of shunting diodes that may further function to eliminate motor induced electro-motive forces that, without the diodes, may add to the rolling friction when the transport device is manually pulled or pushed with the motor inactive. Other manners for reducing motor induced electromotive forces may also be used. One skilled in the art is aware of such technology.

An H-bridge configuration of the forward/reverse circuitry 209 allows a user to control the direction and speed of motor 211 based upon inputs received by circuitry 209. Motor 211 is operatively connected, directly and/or indirectly, to circuitry 209 and is configured to rotate in one of two directions and at various speeds of rotation based upon the inputs to its two leads. Motor 211 may be a direct current, permanent magnet type motor of approximately 100 watts. Motor 211 is configured to propel the transport device and other strapped on items. Motor 211 may be configured to handle loads in excess of 100 lbs., with excess power to adequately climb incline surfaces of several degrees.

Motor 211 is shown operatively connected, directly and/or indirectly, to a drive wheel 213. Drive wheel 213 may be connected, directly and/or indirectly, to motor 211 by a drive belt. Motor-to-drive wheel torque transfer and motor-speed reduction may be accomplished by use of a drive belt. The drive belt may be a cog-belt connected, directly and/or indirectly, to a large and a small cog-gear, the large cog-gear on drive wheel 213 and the small cog-gear on motor 211. Such a configuration provides for lower rolling resistance when the transport device is manually pulled or pushed. Use of a worm-gear type configuration, for example, virtually locks-up the drive wheel 213 when not powered. A cog-belt type drive is quieter, does not require lubrication, and is less expensive to implement and maintain.

Speed/direction input 207, operatively connected, directly and/or indirectly, to the pulse-width modulator controller 203, allows a user to control the speed and rotation direction of motor 211 through the pulse-width modulator controller 203 and circuitry 209. Speed/direction input 207 may be one or more control knobs. As described more fully below, placement of the speed/direction input 207 may be affixed to an external housing of the transport device or connected, directly and/or indirectly, through a detachable electrical cable for remote speed and direction selection.

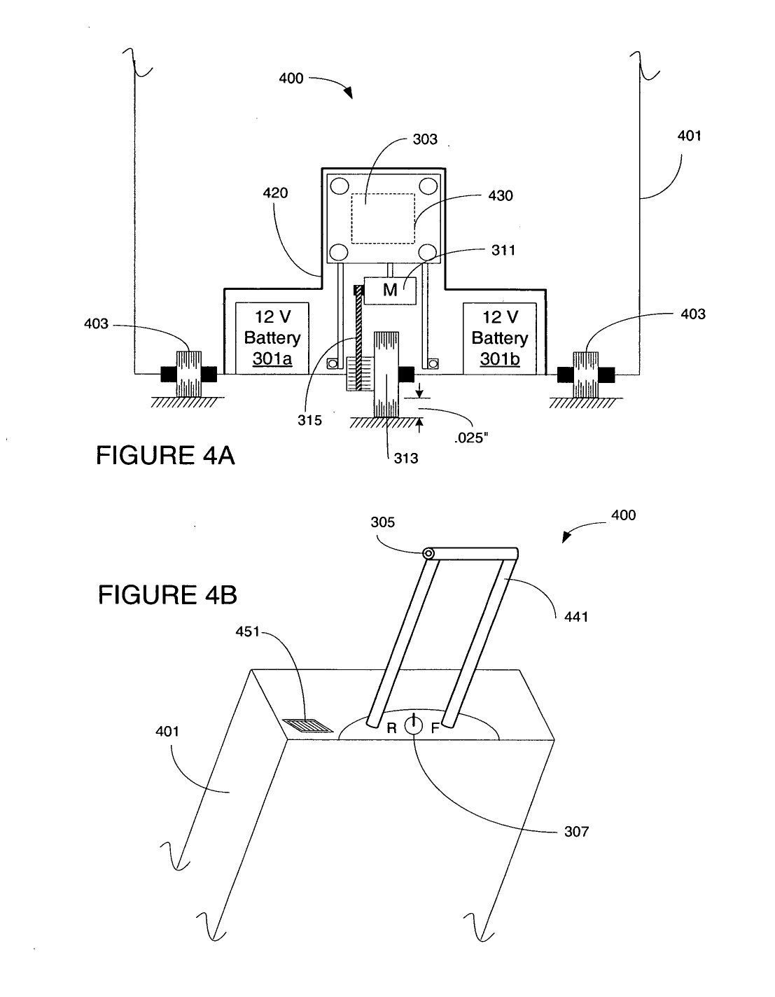

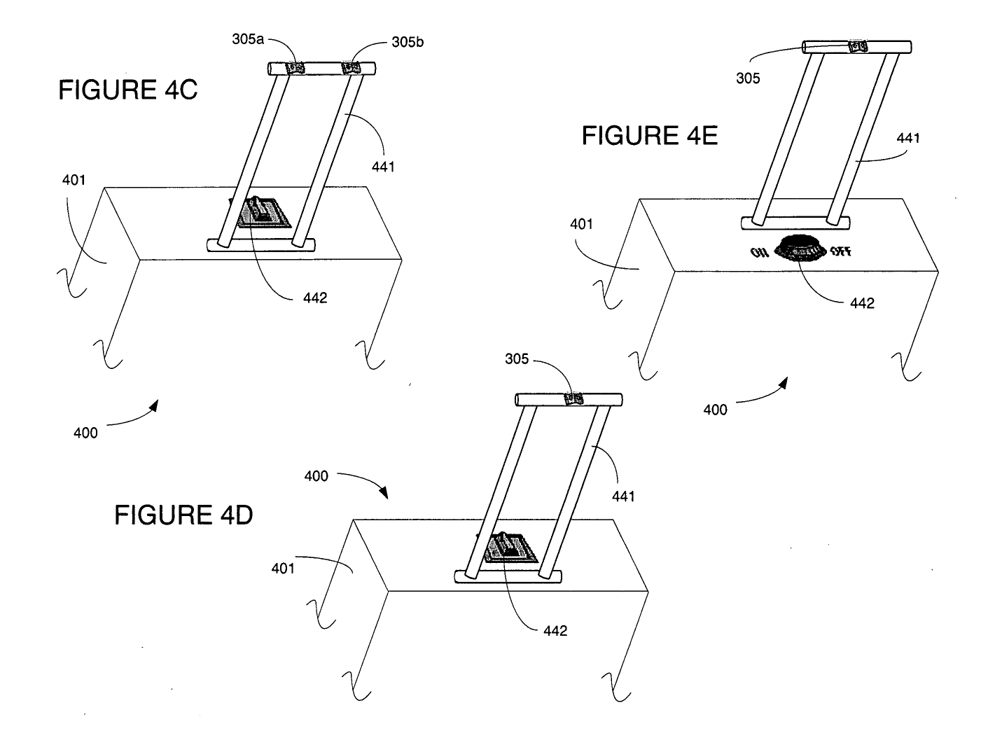

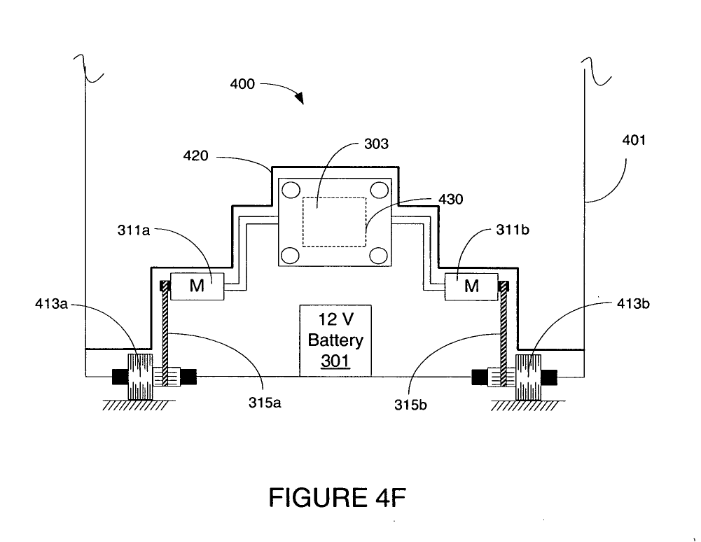

Input switches 205, operatively connected, directly and/or indirectly, to the pulse-width modulator controller 203, allow a user to engage operation of the motor 211 through the pulse-width modulator 203 and circuitry 209 in response to the setting on the speed/direction input 207. Input switches 205 may be dual-pushbutton switches mounted on the right end and the left end of a retractable handle to accommodate left-handed and right-handed operation such as shown in FIG. 4C. The retractable handle, extending from an external housing, may be configured to allow for storage of the retractable handle inside the external housing of the transport device. Use of such a pushbutton type configuration allows for a rapid deactivation of the power-assist unit independent of the speed control setting on the speed/direction input 207. In the case of an emergency stop, such as when an object comes in front of the user, the user merely releases the activation of the pushbutton switch while still holding onto the retractable handle. In such a situation, a twist-grip type speed control system is much more difficult to control deactivation while steering and balancing the transport device. Additionally, a remote pushbutton may be connected, directly and/or indirectly, to the transport device through a detachable electrical cable. In still another embodiment, input switches 205 may be configured within a retractable or non-retractable handle. A cushioned gripping portion of the handle may allow a user to rotate the portion in a rotational manner around the handle in order to engage operation of the motor 211. Upon release of the gripping portion by a user, the device may be automatically configured to disengage the motor 211, thus stopping the device.

Advanced speed control methods are available in the form of a small wireless remote unit in which the transport device speed could be varied by buttons or by moving a lever. A wireless receiver would be internally mounted in the transport device to control the power to motor 211. Powered braking action may be accomplished to traverse a pathway decline of several degrees by setting the speed/direction input 207 to a reverse mode and intermittently activating one of the input switches 205 on the handle.

The power-assisted transport device, herein, is intended to be manually guided at all times. Autonomous or remote steering of luggage is impractical and generally imprudent, not only for reasons of pedestrian safety and luggage security, but also due to the constant attention required to navigate congested walkways, transportation terminals, obstacles, curbs and stairs. As such, the power-assisted transport device of the present invention is manually steered and held by a user during operation in order to allow for easy deactivation of or adjustment to power.

The power-assisted transport device further may be configured to include appropriate connector(s) 219, operatively connected, directly and/or indirectly, to power supply 201. Connector(s) 219 permit accessories compatible with automobile voltage, such as laptop computers, printers, mobile terminal devices, personal digital assistants, music players, portable televisions, game devices, and digital cameras, to be connected, directly and/or indirectly, to use power from power supply 201. As such, when a user is waiting in an airport for a flight, the user can recharge a mobile terminal, play a video game on a game device, and/or work on a laptop by using the power in the transport device.

As used herein, the power-assisted transport device is illustrated with reference to pieces of luggage. It should be understood by those skilled in the art that one or more of the aspects of the present invention described herein may be included within or as other devices. For example, aspects of the present invention may be utilized for infant/toddler strollers and briefcases. In still other embodiments, one or more aspects of the present invention may be utilized in a wheelbarrow or other type of load bearing device.

FIGS. 3A-3B show illustrative diagrams of a power-assisted transport device in accordance with at least one aspect of the present invention. As shown in FIGS. 3A-3B, the power-assisted transport device is shown as a piece of luggage. In FIGS. 3A-3B, luggage 300 has an external housing 317 with an appearance and functionality of a typical suitcase, tilted and hand-guided. Internal components of luggage 300 are shown with an internal frame assembly 333 upon which the power-assist components are attached. The internal frame assembly 333 includes a battery or batteries 301, power controller 303, a motor 311, a drive-belt 315, and a drive-wheel 313. Drive-wheel 313 is shown to extend through a slot or opening in the bottom-end of luggage 300 and is located equidistance between and in parallel alignment with two rollers 348 located on the bottom-end and on either side as with typical luggage. Drive wheel 313 may extend fractions of an inch below the rollers 348 for sufficient drive-wheel traction to propel luggage 300 over a variety of surfaces by the integrated power-assist unit.

As standard practice, a master power switch, a power-on indicator, a power level indicator, and an appropriate fuse may be provided on an externally accessible panel as a means to connect/disconnect, indicate remaining power of, and protect respectively, the power supply 301 and the drive circuitry. In accordance with one embodiment, a pushbutton 305 may be located on the left side and on the right side of a retractable handle 341 of luggage 300. Alternatively or concurrently, a pushbutton 305 may be located on a detachable electrical cable. In accordance with one embodiment, when either pushbutton 305 is activated, power supply 301 is active. When the power unit is not active, luggage 300 may be manually pulled or pushed with a rolling resistance only slightly higher than standard luggage of the same weight. A user may pull on the retractable handle 341 to move luggage 300. When aspects of the present invention are utilized with respect to other embodiments, such as an infant/toddler stroller or wheelbarrow, the retractable handle 341 may be replaced by a stationary handle or folding handle instead.

In accordance with another embodiment, pushbutton 305 may act as a master on/off for operation purposes. Retractable handle 341 may include a gripping portion 307. Gripping portion 307 may be cushioned in order to allow the gripping portion 307 to remain ergonomic with respect to a user's hand. Gripping portion 307 may be configured to allow a user to rotate the gripping portion 307 in a rotational manner around the handle 341 in order to engage operation of the motor 311 and movement of luggage 300. Gripping portion 307 may be configured to automatically disengage the forward or reverse movement of luggage 300 upon release of the gripping portion 307. In accordance with still another embodiment, one or more sensors may be built into the gripping portion 307 in order to sense whether the gripping portion 307 is in contact with a user. If the sensor determines that a user is in contact with the gripping portion 307, the sensor may act as the master on/off switch to turn on/turn off power to the luggage 300. In yet another embodiment, pushbutton 305 may be configured to act as a locking mechanism to maintain the movement of the luggage 300 in a forward or reverse direction and at a speed set by the user. Upon release of the locked pushbutton, such as by activation of the pushbutton 305 a second time, or upon release of the gripped portion 307 by the user, the motor 311 may be disengaged and the luggage 300 stopped.

FIG. 3C illustrates an example schematic diagram of a power-assisted transport device in accordance with at least one aspect of the present invention. As shown, two 12 volt batteries, 301a and 301b, are connected, directly and/or indirectly, in series to supply 24 volts to the pulse-width modulator controller 303. Two pushbutton type input switches 305 are shown connected, directly and/or indirectly, to the pulse-width modulator controller 303. Pulse-width modulator controller 303 is shown outputting to circuitry 309. Circuitry 309 is shown in a standard H-bridge type configuration, including four power field effect transistors. The output of circuitry 309 is shown connected, directly and/or indirectly, to motor 311. In this example, motor 311 is a 24 volt direct current motor at 100 watts. A cog-belt reduction drive 315 connects motor 311 to a drive wheel 313. In this example, drive wheel 313 is shown as a 6 inch drive wheel.

A speed/direction input 307 is shown connected, directly and/or indirectly, to the pulse-width modulator controller 303. Speed/direction input 307 is configured to allow a user to adjust the speed of rotation and direction of rotation of motor 311 through the pulse-width modulator 303 and circuitry 309. As shown in this example, a control knob may be attached to a variable potentiometer to control the speed and direction of movement. The control knob may be located on a retractable handle, on the external housing of the device in a handle storage recess 319, shown in FIG. 3A, and/or on a detachable electrical cable with a pushbutton.

When the control knob is set at the mid-point of its full angle of rotation, no speed or direction for motion is commanded; however, when the control knob is rotated counter-clockwise from its mid-point, the device is configured to move forward (or away) from the direction of the handle when either pushbutton 305 is activated and at a speed determined by the angle of rotation of the control knob from its mid-point. Conversely, when the control knob is rotated clockwise from its mid-point, the direction of motion is reversed and the speed is determined by the angle of rotation from the mid-point. Many other types of speed/direction input 307 may be used and other examples should not be limited to those illustrated herein. For example, speed/direction input 307 may include separate input switches for the speed and for the direction. One control knob may be configured to operate the speed while a switch may be configured to operate direction.

FIG. 4A shows an illustrative cross section diagram of a power-assisted transport device in accordance with at least one aspect of the present invention. As shown, power-assisted transport device 400 is shown in one example arrangement. In this example, two batteries 301a and 301b are shown on each side of the device 400. In this arrangement, the batteries 301a and 301b are equally spaced from the ends of the device 400 and mid-point of the device 400 in order to balance the weight of the batteries 301a and 301b. Rollers 403 are shown partially within the device 400 through the external housing 401. In another embodiment, rollers 403 may be completely external to the external housing 401. Drive wheel 313 is shown partially within the device 400 through the external housing 401 as well. Drive wheel 313 may extend through an opening in the external housing 401 of the device 400. In addition, drive wheel 313 is shown to extend 0.025 inches below the roller 403 to provide sufficient drive wheel traction to propel the device 400 over a variety of surfaces. The distance of 0.025 inches is but one example.

Drive wheel 313 is shown at the mid-point of the device 400 and is connected, directly and/or indirectly, to motor 311 by drive belt 315. Motor 311 is shown centered above the drive wheel 313 with pulse-width modulator 303 centered above the motor 311. Such a configuration creates a balanced load at the lower mid-point of the device 400. Drive wheel 313 may be configured to retract by a predefined distance into the device 400 when the device 400 is in an upright position and/or when the motor 311 is not active. Due to the potential levels of heat dissipation, a heat sink 430 is shown connected, directly and/or indirectly, to the pulse-width modulator. Other heat sinks, as needed, may be used in other locations.

An interior housing 420 may be included to separate the batteries 301a and 301b, the pulse-width modulator controller 303, the circuitry, the motor 311, the drive belt 315, and the drive wheel 313 from a storage area. A user may store clothing and other items for a trip in the storage area while ensuring that contaminants, such as dirt, debris, and oil, do not interact with them. In addition, existing pieces of luggage may be retrofitted to include one or more of these features by creating an opening at a lower mid-point of the luggage for the drive wheel 313 to pass through and securing the interior housing 420 to the interior of the luggage.

FIGS. 4B-4E show illustrative diagrams of a power-assisted transport device in accordance with at least one aspect of the present invention. In FIG. 4B, device 400 is shown with a retractable handle 441 that includes at least one input switch 305. A second input switch 305 may be configured to be located on the other end of the top of the retractable handle 441. Speed/direction input 307 is shown at a location below the retractable handle 441. As shown in this example, a user turns the control dial 307 clockwise to set the direction of the movement of the device 400 to a forward motion. Alternatively, a user turns the control dial 307 counter-clockwise to set the direction of the movement of the device 400 to a reverse motion. The user sets the speed by turning the control dial 307 with respect to the mid-point of the control dial 307. Device 400 is also shown to include a power level indicator 451, such as a visual aide to a user identifying the amount of remaining power of the internal power supply. Although shown in one configuration in FIG. 4B, power level indicator may be smaller or larger and may be included in other locations, such as on the handle 441 or in the same area as the speed/direction input 307. When aspects of the present invention are utilized with respect to other embodiments, such as an infant/toddler stroller or wheelbarrow, the retractable handle 441 may be replaced by a stationary handle or folding handle instead.

In FIG. 4C, device 400 is shown with a retractable handle 441 that includes two input switches 305a and 305b. The two input switches 305a and 305b allow for engaging of the power-assisted motor whether a right handed or left handed user is operating the device 400. Input switches 305a and 305b may be spring-loaded, directional switches. On/off input 442 is shown at a location below the retractable handle 441. On/off input 442 allows a user to turn the power-assisted components of the device 400 on or off. The portion of the handle 441 in which the input switches are included may be a rubber type handle that is ergonomic and/or easy for a user to hold on to during operation. In FIG. 4D, a single input switch 305 is shown in the middle of the top portion of the retractable handle 441. FIG. 4E illustrates how a rotating knob input may be used to operate are an on/off input 442. It should be understood by those skilled in the art that the illustrative examples provided herein so not limit the present invention and any number of different configurations of the components described herein may be utilized.

FIG. 4F shows another illustrative cross section diagram of a power-assisted transport device in accordance with at least one aspect of the present invention. In this example, two rollers 413a and 413b operate as the drive wheels for device 400. One battery 301 is shown centered in the middle lower area of device 400. In this arrangement, battery 301 may be equally spaced from the ends of the device 400 at a mid-point of the device 400 in order to balance the weight of the battery 301. Rollers 413a and 413b are shown partially within the device 400 through the external housing 401. In another embodiment, rollers 403 may be completely external to the external housing 401. In this embodiment, rollers 413a and 413b operate as drive wheels to propel the device 400 over a variety of surfaces.

Rollers 413a and 413b are shown at the mid-point of the device 400 and are connected, directly and/or indirectly, to motors 311a and 311b, respectively, by drive belts 315a and 315b, respectively. Motors 311a and 311b are shown at similar positions above respective drive wheels 313a and 313b and with respect to the ends of the device 400. Pulse-width modulator 303 is shown centered above battery 301. Such a configuration creates a balanced load at the lower mid-point of the device 400. Rollers 413a and 413b may be configured to retract by a predefined distance into the device 400 when the device 400 is in an upright position and/or when the motors 411a and 413b are not active. Due to the potential levels of heat dissipation, a heat sink 430 is shown connected, directly and/or indirectly, to the pulse-width modulator. Other heat sinks, as needed, may be used in other locations. In accordance with one embodiment, more or less power may be applied to motors 311a and 311b to operate in manner similar to power steering. As a user turns the power-assisted device 400 in a generally forward and angled direction, motor 31 la may have more power applied compared to 311b, thus causing roller 413a to rotate faster than roller 413b. In such a case, device 400 will move in a generally forward and angled direction. One or more sensor may be included within the rollers 413a and 413b and or elsewhere to measure the angle of movement. A gyroscope type sensor is but one example of a sensor that may be used. The one or more sensors may be configured to change the amount of power supplied to one or more of the motors 311a and/or 311b.

An interior housing 420 may be included to separate the battery 301, the pulse-width modulator controller 303, the circuitry, the motors 311a and 311b, the drive belts 315a and 315b, and the rollers 413a and 413b from a storage area. A user may store clothing and other items in the storage area while ensuring that contaminants, such as dirt, debris, and oil, do not interact with them. In addition, existing pieces of luggage may be retrofitted to include one or more of these features.

In still another embodiment, one of the two rollers 413a and 413b may be configured to rotate in response to an operatively connected, directly and/or indirectly, motor 311 and drive belt 315 while the other roller freely rotates when a force is applied upon movement across a surface. Although various embodiments have been described herein, it should be understood by those skilled in the art that the present invention is not so limited and that other embodiments in accordance with one or more aspects of the present invention may be utilized.

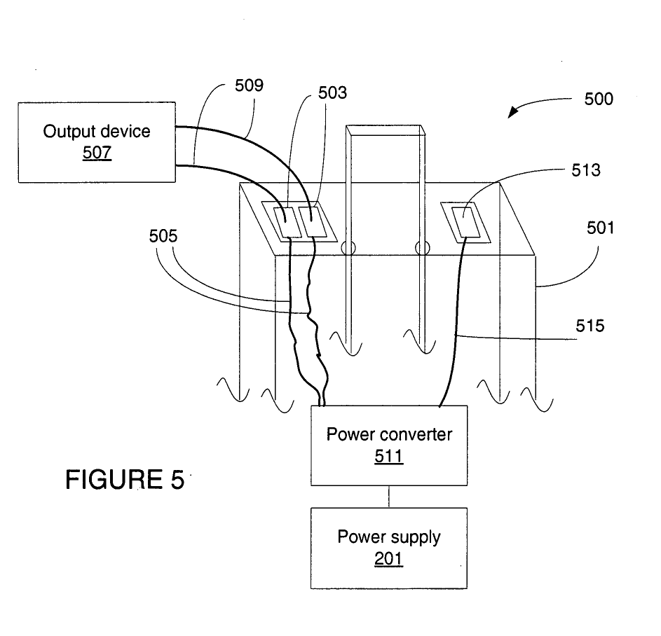

FIG. 5 is an illustrative diagram of a transport device in accordance with at least one aspect of the present invention. Transport device 500 shown in FIG. 5 is configured to include appropriate connections/outlets 503, operatively connected, directly and/or indirectly, to power supply 201 through a power converter 511. Connections/outlets 503 permit an output device 507 to be connected, directly and/or indirectly, to use power from power supply 201. Examples of output devices 507 include, but are not limited to, laptop computers, printers, mobile terminal devices, personal digital assistants, music players, portable televisions, game devices, and digital cameras. Connection lines 509 may be used to connect the output device 507 to the connections/outlets 503. A common electrical plug may be connection lines. Power lines 505 operatively connect the connections/outlets 503 to the power converter 511. Power converter 511 is configured to convert the power outputted from power supply 201 into a suitable format for use by the output device 507. As shown, connections/outlets 503 are affixed to the external housing 501 of the device 500, while the power lines 505, power converter 511, and power supply 201 are shown internal to the device 500. As such, while a user is waiting for a flight to board, the user can recharge a mobile terminal and/or work on a laptop by using the power in the transport device 500.

The power supply may be a rechargeable power supply. For example, as shown in FIG. 5, a connection/inlet 513 is shown affixed to the external housing 501 of the device 500. A power line 515 connects the connection/inlet 513 to the power supply 201 through power converter 511. A user may connect a cord between the connection/inlet 513 and a standard alternating current electrical outlet. As such, a user can recharge the power supply 201 when waiting at the airport for a flight. In one embodiment, connection/inlet 513 may be a retractable cord with a plug on the end for insertion into a standard alternating current electrical outlet. A user pulls the cord with the plug out and inserts it into the electrical outlet to recharge the rechargeable power supply.

While illustrative systems and methods as described herein embodying various aspects of the present invention are shown, it will be understood by those skilled in the art, that the invention is not limited to these embodiments. Modifications may be made by those skilled in the art, particularly in light of the foregoing teachings. For example, each of the elements of the aforementioned embodiments may be utilized alone or in combination or subcombination with elements of the other embodiments. It will also be appreciated and understood that modifications may be made without departing from the true spirit and scope of the present invention. The description is thus to be regarded as illustrative instead of restrictive on the present invention.

We claim:

1. A power-assisted device comprising:
an external housing including an opening;
an interior storage compartment, the interior storage compartment including:
a battery,
a power controller operatively connected to the battery,
circuitry, operatively connected to the power controller, configured to control input of power to a motor, and
the motor, operatively connected to the circuitry, configured to turn a drive belt operatively connected to the motor,
a drive wheel operatively connected to the drive belt, configured to propel the device across a surface; and
at least one input switch, operatively connected to the power controller, configured to engage movement of the device upon activation of the at least one switch.

2. The power-assisted device of claim 1, wherein the external housing includes an opening and the drive wheel is partially located within the interior storage compartment and partially located outside of the external housing through the opening.

3. The power-assisted device of claim 1, further comprising at least one roller, operatively connected to the external housing, configured to rotate in response to application of force.

4. The power-assisted device of claim 1, wherein the battery conforms to FAA regulations for transporting electric-powered devices.

5. The power-assisted device of claim 4, wherein the battery comprises a rechargeable battery.

6. The power-assisted device of claim 4, wherein the battery comprises a rechargeable battery.

7. The power-assisted device of claim 6, wherein the battery is configured to recharge when the drive wheel rotates in response to a force applied from a source other than the motor.

8. The power-assisted device of claim 1, wherein the power controller includes a pulse-width modulator and a heat sink.

9. The power-assisted device of claim 1, wherein the circuitry includes field effect transistors arranged in an H-bridge configuration.

10. The power-assisted device of claim 1, further comprising a handle, extending from the external housing.

11. The power-assisted device of claim 10, further comprising a control input, the control input configured to control the speed of rotation of the motor.

12. The power-assisted device of claim 10, wherein the control input further is configured to control a direction of rotation of the motor.

13. The power-assisted device of claim 10, wherein the control input is located on a detachable electrical cable operatively connected to the power controller.

14. The power-assisted device of claim 10, wherein the at least one input switch is located within the handle.

15. The power-assisted device of claim 10, wherein the handle is a retractable handle and the external housing is configured to allow for storage of the retractable handle inside the external housing.

16. The power-assisted device of claim 15, wherein the at least one input switch includes a gripping portion configured to rotate around the handle to engage movement of the device.

17. The power-assisted device of claim 16, wherein the at least one input switch includes an on/off switch.

18. The power-assisted device of claim 16, wherein the gripping portion is configured to rotate from a first state where no power is supplied to the motor to a second state where power is supplied to the motor.

19. The power-assisted device of claim 1, wherein the device is configured to permit braking of the device across the surface when the at least one input switch is intermittently activated.

20. The power-assisted device of claim 1, further comprising:
an outlet, operatively connected to the external housing, configured to permit insertion of an external device to use the battery; and
power lines, located within the interior storage compartment, connecting the outlet to the battery.

21. The power-assisted device of claim 20, further comprising a power converter configured to convert power from the battery to the outlet.

22. The power-assisted device of claim 1, wherein the device comprises a piece of luggage.

23. The power-assisted device of claim 1, wherein the device comprises an infant/toddler stroller.

24. The power-assisted device of claim 1, wherein the interior storage compartment further includes an interior housing, the interior housing separating the battery, the power controller, the circuitry, the motor, the drive belt, and the drive wheel from a storage area.

25. The power-assisted device of claim 1, wherein the external housing further comprises a power level indicator configured to identify an amount of power remaining in the battery.

26. The power-assisted device of claim 1, further comprising a second drivel wheel, operatively connected to a second drive belt, configured to propel the device across the surface, wherein the interior storage compartment further includes a second motor, operatively connected to the circuitry, configured to turn the second drive belt operatively connected to the second motor, wherein the circuitry is further configured to control the input of power to the second motor.

27. The power-assisted device of claim 26, wherein the interior storage compartment further includes a sensor configured to measure an angle of movement of the device across the surface to change an amount of power applied to the motor and the second motor.

28. A power-assisted luggage comprising:
an exterior housing;
a retractable handle, extending from the exterior housing, configured to allow for storage of the retractable handle inside the exterior housing;
a frame assembly, including:
a power supply,
a pulse-width modulator controller operatively connected to the power supply,
circuitry, operatively connected to the pulse-width modulator controller, configured to permit movement of the luggage in at least two directions,
a direct current motor, operatively connected to the circuitry, configured to turn a drive belt operatively connected to the direct current motor, and
a drive wheel, operatively connected to the drive belt, configured to propel the luggage; and
at least one input switch, located within the retractable handle and operatively connected to the pulse-width modulator controller, configured to engage movement of the luggage upon activation of the at least one switch.

29. The power-assisted luggage of claim 28, further comprising a control input, operatively connected to the pulse-width modulator controller, configured to control a direction of movement of the luggage and a speed of movement of the luggage.

30. The power-assisted luggage of claim 28, further comprising a remote unit, wirelessly connected to the pulse-width modulator controller, configured to control a direction of movement of the luggage and a speed of movement of the luggage.

31. A piece of luggage, comprising:
an exterior housing;
an interior storage area;
a power supply, located within the interior storage area;
a connection, operatively connected to the exterior housing, configured to permit insertion of an external device to use the power supply; and
power lines, located within the interior storage area, connecting the connection to the power supply.

32. The luggage of claim 31, further comprising a power converter configured to convert power from the power supply to the connection.
